(19) United States
(12) Patent Application Publication
(10) Pub. No.: US 2006/0265084 A1
(43) Pub. Date: Nov. 23, 2006

(54) Internet washing machine and method for operating the same

(75) Inventor: Gyeong-Ho Moon, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/562,991

(22) PCT Filed: May 18, 2005
(86) PCT No.: PCT/KR05/01456

§ 371 Date: Jul. 5, 2006

(30) Foreign Application Priority Data
May 20, 2004 (KR) 10-2004-0036069

(51) Int. Cl. G05B 11/01

(52) U.S. Cl. 700/11; 700/2

(57) ABSTRACT

An Internet washing machine is disclosed. The washing machine comprises a communication modem connected to a communication network for transmitting/receiving data over the communication network, a display unit for displaying whether the washing machine is communicable, and a control unit for determining a network connection state and communication state of the communication modem and displaying through the display unit whether the washing machine is communicable, in accordance with results of the determination. Whether the Internet washing machine is communicable is displayed through the display unit so that the user can more easily recognize the network communication state of the washing machine. This increases the user's convenience.

### TECHNICAL FIELD

The present invention relates to an Internet washing machine, and more particularly, to an Internet washing machine and a method for operating the same, wherein the user can readily recognize the communication state of the washing machine.

### BACKGROUND ART

Generally, a washing machine is an electric home appliance, which is most widely used in homes to remove contaminants attached to laundry by utilizing softening action of detergent, frictional action of wash water flows generated due to rotational action, impact of the wash water flows applied to the laundry, etc.

For such washing machines for domestic purposes, products of various washing types, for example, a pulsator type, an agitator type, and a drum type, are commercially available. Such washing machines may also be classified into a separation type and a full automation type in terms of whether or not washing and spin-drying tubs are separated from each other.

In a separation type washing machine, in which washing and spin-drying tubs are separated from each other, washing and rinsing processes are carried out as a pulsator arranged on the bottom of the washing tub generates waves in the washing tube while rotating alternately in left and right directions. In this case, a spin-drying process is also carried out as the spin-drying tub rotates at high speed to generate centrifugal force, thereby spin-drying laundry.

On the other hand, in a full automation type washing machine, washing and spin-drying tubs thereof are arranged to form a concentric double tub structure. In this case, washing and rinsing processes are carried out as a pulsator protruded from the bottom of the outer tub through the inner tub rotates. In a spin-drying process, the inner tub, which is formed with a plurality of holes, rotates at high speed, thereby spin-drying laundry.

For most washing machines, the user uses the washing machines by properly setting washing conditions, such as washing time, rinsing time, spin-drying time, and so forth, according to the materials or amount of laundry.

A plurality of washing course programs are pre-stored in a memory so that they can be selectively utilized by the user to perform automatic washing for the user's convenience.

For example, a variety of washing course programs, such as centrifugal washing, high-concentration washing, prewashing, vibration washing, annealing washing, wool washing, etc., are pre-stored in the memory so that the user can simply and conveniently select a desired washing course to execute the automatic washing.

Meanwhile, nowadays, as the use of the Internet is popularized, customer concerns and desires for a home network are increasing. For this reason, in spite of the repeated development of washing machines for the user's convenience as mentioned above, it is next to impossible to expect that the customers will be satisfied with only the existing washing machines.

Recently, a home network system that connects home appliances in a home to a network and manages/controls them in an integrated manner has been developed and introduced to the market.

In this home network system, one or more home appliances and a home server capable of centrally controlling the home appliances are interconnected over a network constructed in a building or home so that they can mutually control the operations thereof.

In particular, applicable to the home network system are various communication systems using a wireless network capable of transmitting and receiving data by transmitting and receiving wireless signals of a specific frequency band, a power line network which is a communication network constructed without separate equipment by using a power line constructed in a building, a network based on existing local area network (LAN) equipment, and so forth.

In order to increase customer satisfaction with the washing machines through the development of such a home network system, there is a need for the supply of an Internet accessible washing machine.

### DISCLOSURE OF INVENTION

### Technical Problem

Accordingly, the present invention is directed to an Internet washing machine and a method for operating the same that substantially obviate one or more problems due to limitations and disadvantages of the related art.

An object of the present invention is to provide an Internet washing machine which can be connected to a network to communicate with a home server or other home appliances.

Another object of the present invention is to provide a method for operating an Internet washing machine, wherein the connection state of the washing machine with a network or whether data transmission/reception of the washing machine is possible is displayed so that it can be recognized by the user.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these objects and other advantages and in accordance with the purpose of the invention, as embodied and broadly described herein, an Internet washing machine comprises a communication modem connected to a communication network for transmitting/receiving data over the communication network; a display unit for displaying whether the washing machine is communicable; and a control unit for determining a network connection state and communication state of the communication modem and displaying through the display unit whether the washing machine is communicable, in accordance with results of the determination.

The communication modem may be any one of a wireless communication modem, a power line communication modem and a local area network (LAN) modem.

Preferably, the display unit includes a first display part for displaying an operating state and washing information of the washing machine; and a second display part for displaying a network communication state of the washing machine.

The display unit may include any one of a light emitting diode (LED), a liquid crystal display (LCD) and a full graphic LCD.

Preferably, the control unit includes a communication state checker for checking a network communication state of the communication modem; and a display controller for controlling the display unit to display the communication state checked by the communication state checker through the display unit.

In another aspect of the present invention, there is provided a method for operating an Internet washing machine, the washing machine being connected to a communication network to perform network communication, the method comprising the steps of a) determining whether the washing machine is in connection to the communication network and whether the washing machine can transmit and receive data over the communication network; and b) displaying through display means whether the washing machine is communicable, in accordance with results of the determination.

Preferably, the step a) includes the steps of determining whether the washing machine is in connection to the communication network, upon supply of power to the washing machine; and determining whether the washing machine can transmit and receive data over the communication network, if the washing machine is in connection to the communication network.

Preferably, the step b) includes the steps of, if the washing machine is in connection to the communication network and can transmit and receive data over the communication network, displaying the fact that the washing machine is in a communication enable state; and, if the washing machine is not in connection to the communication network or if the washing machine cannot transmit and receive data over the communication network, displaying the fact that the washing machine is in a communication disable state.

It is to be understood that both the foregoing general description and the following detailed description of the present invention are exemplary and explanatory and are intended to provide further explanation of the invention as claimed.

### Advantageous Effects

As apparent from the above description, the present invention has effects as follows.

Firstly, an Internet washing machine is provided which is communicable with a server or other terminals. It is thus possible to increase the satisfaction of a customer using the washing machine.

Secondly, whether the Internet washing machine is communicable is displayed through display means so that the user can more easily recognize the network communication state of the washing machine. This increases the user's convenience.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing the configuration of an Internet washing machine according to the present invention;

FIGS. 2 (a) to (c) are views illustrating exemplary display fashions of a display unit in the Internet washing machine according to the present invention;

FIG. 3 is a view illustrating another exemplary display fashion of the display unit in the Internet washing machine according to the present invention; and

FIG. 4 is a flow chart illustrating a method for operating the Internet washing machine according to the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

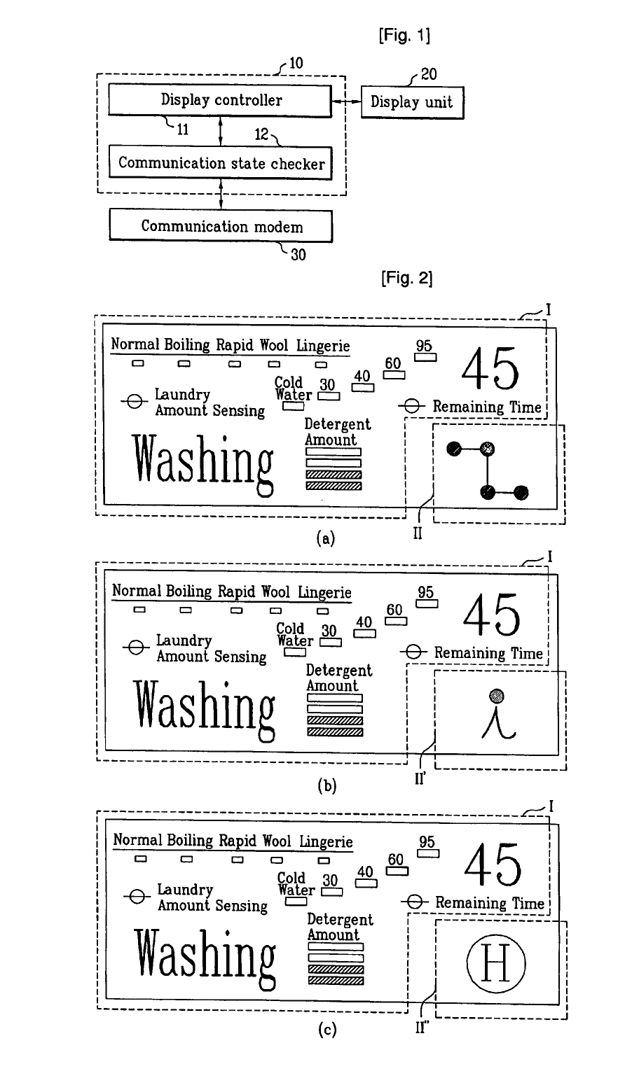

FIG. 1 is a block diagram showing the configuration of an Internet washing machine according to the present invention, and FIGS. 2 (a) to (c) and FIG. 3 illustrate various exemplary display fashions which indicate whether the Internet washing machine is communicable.

As shown in FIG. 1, the Internet washing machine according to the present invention comprises a communication modem 30 connected to a communication network for transmitting/receiving data over the communication network, a display unit 20 for displaying the communication state of the communication modem 30, and a control unit 10 for determining the network connection state and communication state of the communication modem 30 and displaying through the display unit 20 whether the washing machine is communicable, in accordance with the determination results.

The communication modem 30 is adapted to enable the transmission/reception of data to/from a server or different terminal by transmitting data to be transmitted, on the basis of an associated communication protocol, and reading received data so as to be recognizable by the control unit 10.

Here, the communication modem 30 may be a wireless communication modem such as a Bluetooth modem, a power line communication modem using a power line, or an LAN modem such as an Ethernet modem, according to the type of the network.

The display unit 20 of the washing machine is composed of, as shown in FIGS. 2 (a) to (c) and FIG. 3, a first display part I for displaying the operating state, washing information, etc. of the washing machine, and a second display part II, II′ or II″ for displaying the current communication state of the washing machine.

Here, the first display part I is adapted to display general washing information and the operating state of the washing machine, such as a washing course, a washing time, the amount of water supplied, etc.,

The second display part II, II′ or II″ is adapted to display whether the washing machine is in connection to the communication network and can transmit and receive data over the network.

Here, the display unit 20 employs display means, such as a light emitting diode (LED), a liquid crystal display (LCD), or a full graphic LCD.

Where the display unit 20 is provided with an LCD or full graphic LCD, it includes, as shown in FIGS. 2 (a) to (c), the second display part II, II′ or II″ which is a display area for representing the communication state of the washing machine.

That is, as shown in FIGS. 2 (a) to (c), the display unit 20 displays a corresponding one of logos indicative of a communication enable state of the washing machine at the second display part II, II′ or II″.

It will be understood that the communication enable state indicating logos and the logo display positions in the display unit 20 are shown only for illustrative purposes and not limited to this specification, and can be applied in various ways by those skilled in the art.

On the other hand, in the case where the second display part II includes a separate LED as shown in FIG. 3, it is printed with a specific character or symbol (for example, “H/Net”) so that the user can readily recognize the LED to be means for displaying the communication state of the washing machine.

With the above-stated configuration, when it is determined that the washing machine can transmit and receive data, the LED is turned on to display the fact that the washing machine is in the communication enable state.

The control unit 10 includes a communication state checker 12 for checking the network communication state of the communication modem 30, and a display controller 1 1 for controlling the display unit 20 to display the communication state checked by the communication state checker 12 through the display unit 20.

The communication state checker 12 is adapted to determine whether the washing machine is in organic connection to the communication network through the communication modem 30 and whether the washing machine can transmit and receive data over the connected communication network.

The display controller 11 is adapted to, if the communication state checker 12 determines that the washing machine can transmit and receive data, control the display unit 20 to display the fact that the washing machine is in the communication enable state.

A detailed description will hereinafter be given of a method for operating the Internet washing machine with the above-stated configuration according to the present invention.

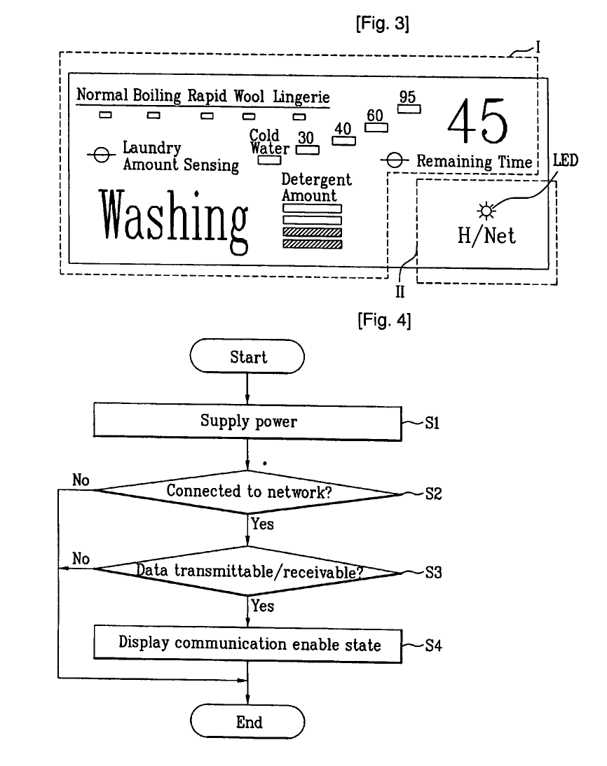

FIG. 4 is a flow chart illustrating the method for operating the Internet washing machine according to the present invention.

As shown in FIG. 4, upon supply of power to the Internet washing machine of the present invention (S1), the control unit 10 determines whether the communication modem 30 is in connection to the communication network (S2).

If the communication modem 30 is determined to be in connection to the communication network at step S2, the control unit 10 checks the communication state of the communication network to determine whether the washing machine can transmit and receive data over the network (S3).

Upon determining at step S3 that the washing machine can transmit and receive data over the connected network, the control unit 10 displays the fact that the washing machine is in a communication enable state, through the display unit 20 (S4).

In other words, the control unit 10 displays the current communication state of the washing machine through the display unit 20 so that the user can recognize the washing machine to be communicable over the network.

At this time, in the case where the display unit 20 is provided with an LCD, it displays a specific logo indicative of the communication enable state at a corresponding area of the LCD. Alternatively, in the case where the display unit 20 includes an LED, it turns the LED on to indicate the communication enable state.

On the other hand, if the communication modem 30 is determined not to be in connection to the communication network at step S2 or if it is determined at step S3 that the washing machine cannot transmit and receive data over the network, the control unit 10 displays no communication state at the second display part II, II′ or II′ of the display unit 20 to indicate that the washing machine is in a communication disable state.

Therefore, the Internet washing machine according to the present invention displays whether it is communicable, at a specific area of the display means, so that the user can easily recognize the network communication state of the washing machine.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An Internet washing machine comprising:
a communication modem connected to a communication network for transmitting/receiving data over the communication network;
a display unit for displaying whether the washing machine is communicable; and
a control unit for determining a network connection state and communication state of the communication modem and displaying through the display unit whether the washing machine is communicable, in accordance with results of the determination.

2. The Internet washing machine as set forth in claim 1, wherein the communication modem is a wireless communication modem.

3. The Internet washing machine as set forth in claim 1, wherein the communication modem is a power line communication modem.

4. The Internet washing machine as set forth in claim 1, wherein the communication modem is a local area network (LAN) modem.

5. The Internet washing machine as set forth in claim 1, wherein the display unit includes:
a first display part for displaying an operating state and washing information of the washing machine; and
a second display part for displaying a network communication state of the washing machine.

6. The Internet washing machine as set forth in claim 1, wherein the display unit includes a light emitting diode (LED).

7. The Internet washing machine as set forth in claim 1, wherein the display unit includes a liquid crystal display (LCD).

8. The Internet washing machine as set forth in claim 1, wherein the display unit includes a full graphic LCD.

9. The Internet washing machine as set forth in claim 1, wherein the control unit includes:
a communication state checker for checking a network communication state of the communication modem; and
a display controller for controlling the display unit to display the communication state checked by the communication state checker through the display unit.

10. A method for operating an Internet washing machine, the washing machine being connected to a communication network to perform network communication, the method comprising the steps of:
a) determining whether the washing machine is in connection to the communication network and whether the washing machine can transmit and receive data over the communication network; and
b) displaying through display means whether the washing machine is communicable, in accordance with results of the determination.

11. The method as set forth in claim 10, wherein the step a) includes the steps of:
determining whether the washing machine is in connection to the communication network, upon supply of power to the washing machine; and
determining whether the washing machine can transmit and receive data over the communication network, if the washing machine is in connection to the communication network.

12. The method as set forth in claim 10, wherein the step b) includes the step of, if the washing machine is in connection to the communication network and can transmit and receive data over the communication network, displaying the fact that the washing machine is in a communication enable state.

13. The method as set forth in claim 10, wherein the step b) includes the step of, if the washing machine is not in connection to the communication network or if the washing machine cannot transmit and receive data over the communication network, displaying the fact that the washing machine is in a communication disable state.
